(19) United States
(12) Patent Application Publication
(10) Pub. No.: US 2005/0275624 A1
(43) Pub. Date: Dec. 15, 2005

(54) Hand-held communication device having folding joystick

(75) Inventor: Lovleen Chadha, San Diego, CA (US)

Correspondence Address: Attn: Elsa Keller, Legal Administrator;Siemens Corporation, Intellectual Property Department, 170 Wood Avenue South, Iselin, NJ, 08830, US

(73) Assignee: Siemens Information and Communication Mobile LLC

(21) Appl. No.: 10/868,613

(22) Filed: Jun. 14, 2004

(51) Int. Cl. G09G 5/00

(52) U.S. Cl. 345/156

(57) ABSTRACT

A folding joystick assembly for a hand-held communication device includes a joystick that is extended from a recess in the housing of the device during use and folded back into the recess for ease of storage and/or improved portability. When extended, the joystick is manipulated by the user's hand for interacting with applications executed or run by the hand-held communication device to control functions of the device.

### BACKGROUND OF THE INVENTION

The present invention relates generally to hand-held communication devices such as mobile telephones, palmtop computers, personal digital assistants (PDA's) or the like, and more particularly, to a folding joystick for hand-held communication devices.

Hand-held communication devices, particularly mobile telephones, personal digital assistants (PDA's), and the like, comprise a class of portable electronic devices, whose size enables them to be held in one hand while being operated with the other or to be both held and operated by one hand. Typically, such hand-held communication devices employ input devices such as a keypad, a digitizer, or the like, for inputting data.

Many hand-held communication devices support gaming applications for the entertainment of their users. Such gaming applications often employ characters that must be precisely manipulated while playing the game. However, input devices commonly provided by hand-held communication devices (i.e., the keypad, a navigation key assembly of the keypad, the digitizer, or the like) do not readily allow accurate manipulation of indicia such as a cursor or gaming character, since the controls are clumsy to use and do not support true 360 degree movement of the indicia. Moreover, analog input devices such as joysticks typically used with home computers, laptop computers, gaming consoles, and the like, are too bulky for use by hand-held communication devices due to the small size of the devices. As a result, users often find software or gaming applications supported by the hand-held devices difficult to use, lessening the utility of the devices to the user.

As the gaming applications supported by hand-held communications devices become more complex, the need for gaming controls, in particular a joystick-like control device, becomes more pronounced (e.g., for providing directional control for a flight simulation game, for providing a throttle control for a racing game, or the like). One way of furnishing gaming controls for hand-held communication devices has been to provide an accessory gaming console to which the hand-held communication device is attached while playing games. However, transport and storage of such consoles when they are not being used is often inconvenient.

Consequently, it would be desirable to provide a joystick gaming control for a hand-held communication device that may stored within the device when not being used.

### SUMMARY OF THE INVENTION

The present invention is directed to a folding joystick assembly for a hand-held communication device. The folding joystick assembly includes a joystick that is extended from a recess in the housing of the device during use and folded back into the recess for ease of storage and/or improved portability. When extended, the joystick is manipulated by the user's hand (e.g. by the user's index finger) for interacting with applications executed or run by the hand-held communication device to control functions of the device.

In specific embodiments, the present invention provides a hand-held communication device including a housing configured to be held in the hand of the user. The housing includes a first surface, which generally faces toward the user while the user holds the housing, and a second surface, which generally faces away from the user while the user holds the housing. A folding joystick assembly is disposed in the second surface of the housing. The joystick assembly includes a joystick for controlling functions of the hand-held communication device. The joystick folds between a first position within the housing for storage of the joystick and a second position extending from the housing for manipulation by the user. The hand-held communication device may also include a navigation key assembly disposed in the first surface of the housing, which may be used in cooperation with the joystick assembly for controlling functions of the hand-held communication device. In embodiments of the invention, the joystick assembly includes an analog measuring device, such as a potentiometer, for measuring movement of the joystick. In other embodiments, the joystick may be coupled to a digital measuring device, such as a contact switch, for detecting such movement.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

FIG. 1 is an isometric view illustrating a hand-held communication device, in particular, a folding mobile telephone, having a folding joystick in accordance with an exemplary embodiment of the present invention;

FIG. 2 is an end view of the hand-held communication device illustrated in FIG. 1;

FIG. 3 is an isometric view illustrating a hand-held communication device, in particular, a conventional mobile telephone, having a folding joystick in accordance with another exemplary embodiment of the present invention;

FIG. 4 is an end view of the hand-held communication device illustrated in FIG. 3;

FIG. 5 is a partial cross-sectional side elevation view of the hand-held communication device illustrated in FIG. 3, illustrating extension and retraction of the joystick;

FIG. 6 is a partial cross-sectional end elevation view of the hand-held communication device illustrated in FIG. 3, wherein the joystick is extended for use;

FIG. 7 is a partial cross-sectional end elevation view of the hand-held communication device illustrated in FIG. 3, wherein the joystick is folded within the housing of the device;

FIG. 8 is an isometric view illustrating a hand-held communication device having a folding joystick in accordance with a further exemplary embodiment of the present invention;

FIG. 9 is a partial cross-sectional side elevation view of the hand-held communication device illustrated in FIG. 8;

FIGS. 10 and 11 are isometric views illustrating exemplary folding joystick assemblies for a hand-held communication device, wherein the joystick assemblies employ linear potentiometers for sensing movement of the joystick in two dimensions; and

FIGS. 12 and 13 are isometric views illustrating a folding joystick assembly for a hand-held communication device, wherein the joystick assemblies employ rotary potentiometers for sensing movement of the joystick in two dimensions.

### DETAILED DESCRIPTION OF SPECIFIC EMBODIMENTS

Reference will now be made in detail to the presently preferred embodiments of the invention, examples of which are illustrated in the accompanying drawings.

FIGS. 1 through 4 illustrate exemplary hand-held communication devices 100 having folding joystick assemblies 102 in accordance with exemplary embodiments of the present invention. As shown, the hand-held communication device 100 includes a housing 104 configured to be held in the hand 106 of the user. The housing 104 includes a first surface or front side 108, which generally faces toward the user (i.e., the head and torso of the user) while the user holds the housing 104 of the device 100 to use the device 100, and a second surface or back side 110, which generally faces away from the user while the user holds the housing 104 of the device 100. The first surface 108 may include a display 112 and a keypad 114. The keypad 114 may include a navigation key assembly 116 having one or more navigation and selection keys for controlling the display of information by the display 112. For example in the embodiments illustrated, the navigation key assembly 116 includes a multi-directional (e.g., four-way) navigation key 118 and two selection keys 120.

As shown in FIGS. 1 through 4, the folding joystick assembly 102 is positioned within the second surface 110 of the housing 104 opposite the keypad 114 and/or display 112. The folding joystick assembly 102 includes ajoystick 122 positioned within a recess 124 formed in the second surface 110 of the housing 104. The joystick 122 is hinged to fold between a first or folded position, wherein the joystick 122 is held within the recess 124 for storage of the joystick 122 and a second, extended or rest position, wherein the joystick 122 extends from the recess 124 for manipulation by the user. The joystick 124 may be manipulated by the fingers of the user's hand 106 (e.g. by the user's index finger 126) for providing continuously variable data for interacting with applications supported by the hand-held communication device 100. For instance, the joystick 122 may be manipulated by the user for specifying the force at which a bowling ball displayed by the display 1112 is thrown in a bowling game application, or as a throttle for inputting a desired speed for an automobile displayed by the display 112 in an automobile racing application.

The joystick assembly 102 may further be used in cooperation with keys of the keypad 114, particularly, the keys 118 and 120 of the navigation key assembly 116, for controlling functions of the hand-held communication device 100. For example, in the embodiment illustrated, the user may manipulate the navigation key 1118 and selection keys 120 of the navigation key assembly 116 with his or her thumb 126 (or, alternatively, another finger of his or her hand) to provide directional input (e.g. up, down, left, right), while manipulating the joystick 122 as a throttle to provide force and/or speed input. In still further embodiments, the joystick 122 may be used as a trigger for initiating a weapon firing event in a combat gaining application. In this manner, control of functions provided by the hand-held communication device may be accomplished using only the hand holding the device 100.

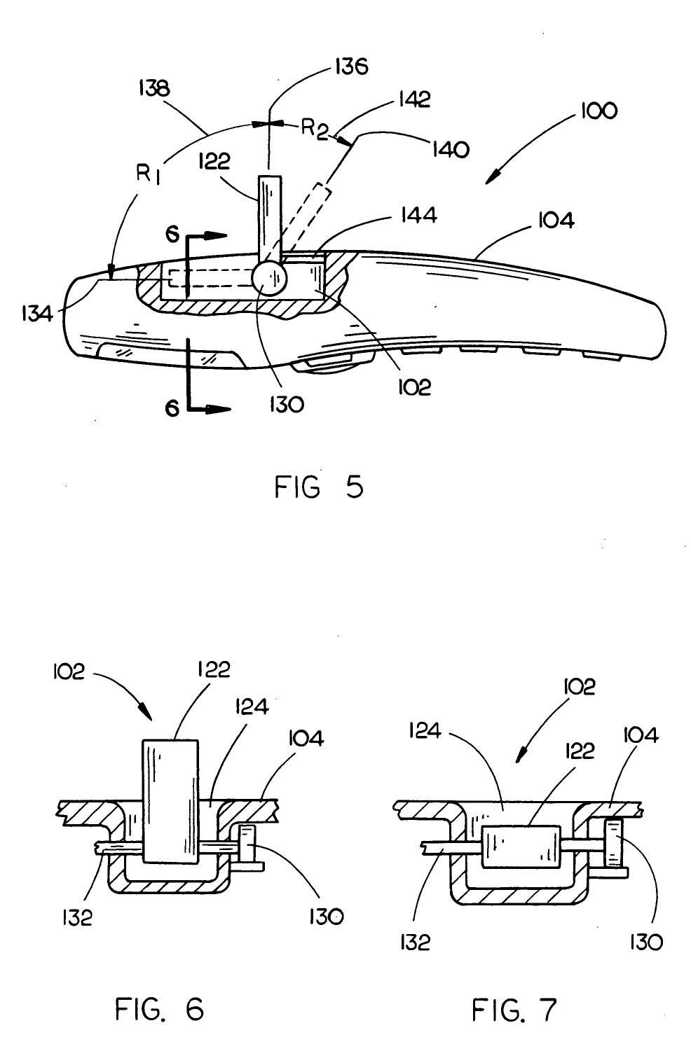

FIGS. 5 through 7 further illustrate the joystick assembly 102 of the hand-held communication device 100 shown in FIGS. 1 though 4. The joystick assembly 102 employs a rotary potentiometer 130 for measuring movement of the joystick 122 about a single axis (i.e., within a single plane). In the exemplary embodiment illustrated, a shaft 132 couples the joystick 122 to the rotary potentiometer 130 which is positioned within the housing 104. As the joystick 122 is pulled by the user, the resistance of the analog output signal provided by the rotary potentiometer 130 varies in proportion to the position of the joystick 122 (i.e., the amount the joystick 122 is pulled). The analog output signal of the rotary potentiometer 130 is then converted to a digital signal via an analog-to-digital converter (ADC), or the like, and provided to the processing system of the hand-held communication device, where the signal may be used as an input to a software application being executed by the processing system.

As shown in FIG. 5, the rotary potentiometer 130 may be inactive as the joystick 122 is unfolded, i.e., when the joystick 122 is rotated between a folded position 134 and an extended or rest position 136 through the range (R₁) 138. In this manner, the joystick 122 may be moved between the folded and extend positions 134 and 136 without providing an input to the hand-held communication device 100, while minimizing power consumption by the potentiometer 130. Once the joystick 122 is extended, i.e., the joystick 122 reaches the end of range (R₁) 138 and is in the extended or rest position 136, the rotary potentiometer 130 becomes active so that the resistance of the analog output signal provided by the potentiometer 130 varies in proportion to the angle of the joystick 122 (i.e., the amount the joystick 122 is pulled from the extended or rest position 136 to a maximum travel position 140 through a second range (R₂) 142). It will be appreciated that the joystick 122 may be held at any intermediate position between the rest and maximum travel positions 136 and 140. As the joystick 122 is folded into the recess 124, i.e., the joystick 122 is returned from the extended or rest position 136 to the folded position 134, the rotary potentiometer 130 may again be deactivated so that no input is provided to the hand-held communication device 100 and power consumption by the potentiometer 130 is reduced.

In the embodiment shown, the joystick assembly 102 further includes a spring assembly 144 for providing resistance to movement of the joystick 122 giving the user greater control of the movement of the joystick 122. When the joystick 122 is released, the spring assembly 144 may cause the joystick to return to the rest position 136. Alternatively, the spring assembly 144 may allow the joystick 122 to remain in its last position before release by the user. Depending on design preferences, the spring assembly 144 may include a compression spring, a tension spring, a combination of compression and tension springs, electromechanical springs, shock absorber devices, or the like, to provide resistance to movement of the joystick 122. Alternatively, the spring assembly 144 may be eliminated and the potentiometer 130 used for providing resistance to movement of the joystick 122.

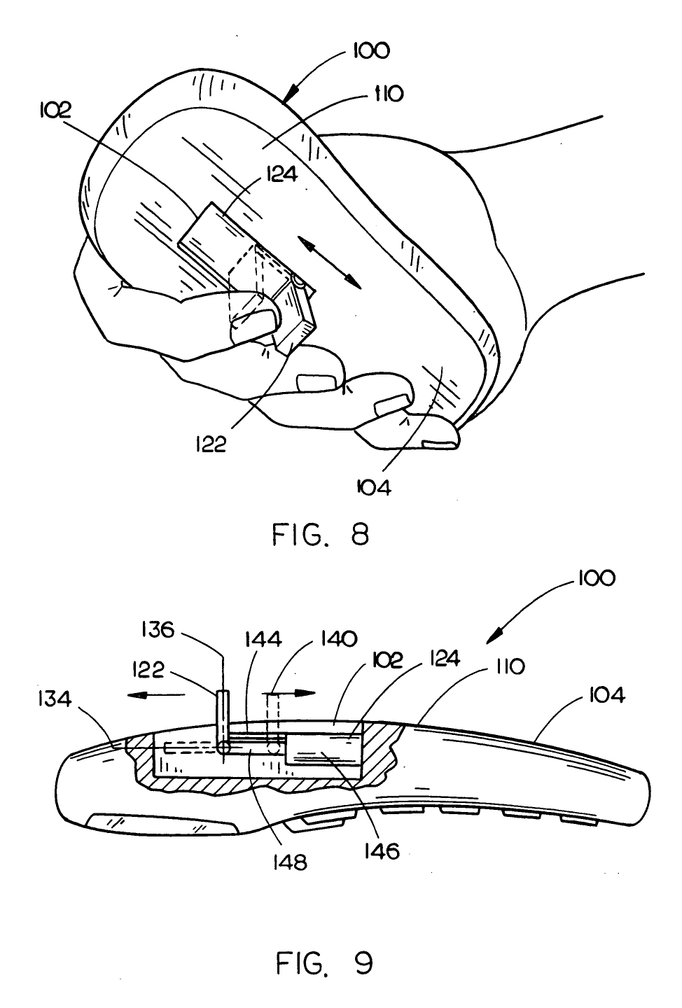

FIGS. 8 and 9 depict a hand-held communication device 100 having a joystick assembly 102 employing a linear potentiometer 146. The linear potentiometer 146 is used to measure linear movement of the folding joystick 122. Like the joystick assembly 102 illustrated in FIGS. 1 through 7, the joystick assembly 102 shown in FIGS. 8 and 9 includes a joystick 122 positioned within a recess 124 formed in the second surface 110 of the housing 104 of the hand-held communication device 100. The joystick 122 is hinged to fold between a first position 134, wherein the joystick 122 is held within the recess 124 for storage of the joystick 122 and a second position 136, wherein the joystick 122 extends from the recess 124 for manipulation by the user.

In the exemplary embodiment illustrated, a shaft 148 couples the joystick 122 to the linear potentiometer 146. As the joystick 122 is pulled by the user, the resistance of the analog output signal provided by the linear potentiometer 146 varies in proportion to the linear position of the joystick 122 (i.e., the amount the joystick 122 is pulled). The analog output signal of the linear potentiometer 146 is then converted to a digital signal via an analog-to-digital converter (ADC), or the like, and provided to the processing system of the hand-held communication device, where the signal may be used as an input to a software application being executed by the processing system. The joystick 122 may be held at any intermediate position between the rest position 136 and a maximum travel position 140.

In exemplary embodiments, a spring assembly 144 provides resistance to movement of the joystick 122 giving the user greater control of the movement of the joystick 122. When the joystick 122 is released, the spring assembly 144 may cause the joystick to return to the rest position 136, or, alternatively, allow the joystick 122 to remain in its last position before release by the user. Depending on design preferences, the spring assembly 144 may include a compression spring, a tension spring, a combination of compression and tension springs, electromechanical springs, shock absorber devices, or the like. Alternatively, the spring assembly 144 may be eliminated and the potentiometer 146 used for providing resistance to movement of the joystick 122.

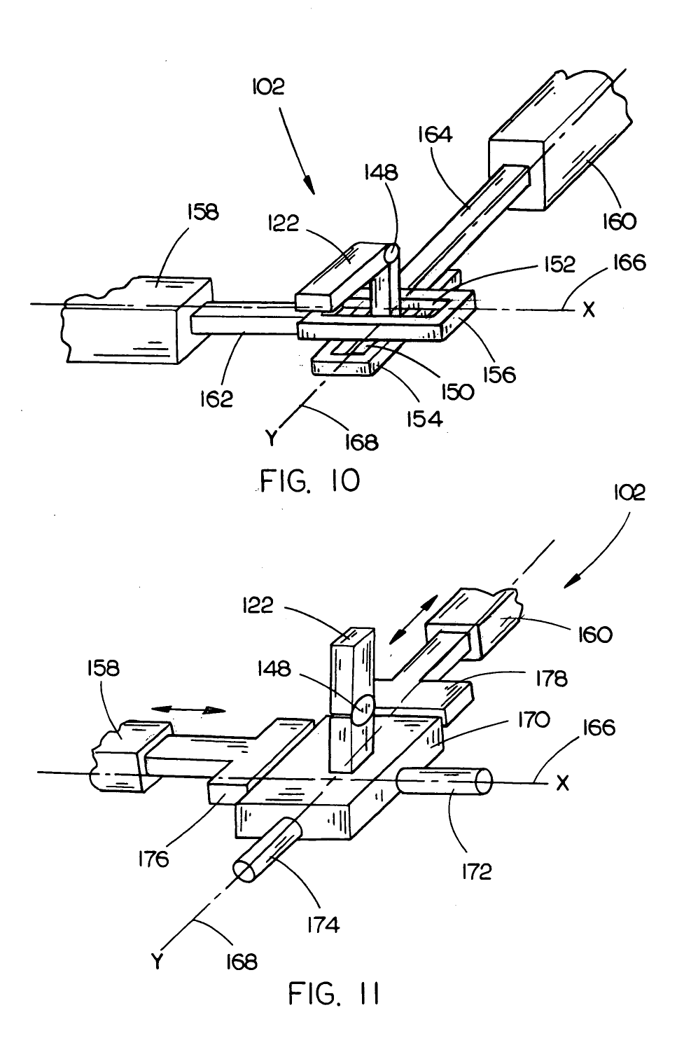

Referring to FIGS. 10 through 13, folding joystick assemblies 102 capable of allowing movement of the joystick 122 to be measured along more than one axis are described. Like the joystick assembly 102 illustrated in FIGS. 1 through 9, the joystick assemblies 102 shown in FIGS. 10 though 13 include a joystick that is hinged to fold between a first position or retracted position, shown in FIG. 10, and a second or extended position 136, shown in FIGS. 11, 12 and 13, wherein the joystick 122 may be manipulated by the user. Because the joystick 122 may be manipulated in two dimensions instead of one, the joystick 122 may include a hinge assembly 148 having an integral locking mechanism for holding the joystick 122 in the extended position until the joystick 122 is intentionally folded. Preferably, the sizes, particularly the thicknesses, of the joystick assemblies 102 illustrated in FIGS. 10 through 13 may be made sufficiently small that the assemblies 102 will not unnecessarily increase the size of the hand-held communication device 100 in which they are used.

In one embodiment, shown in FIG. 10, the joystick 122 extends through slots 150 and 152 in overlapping slide members 154 and 156 so that the joystick 122, when extended, may slide within the slots 150 and 152 and/or push against the sides of the slots 150 and 152. The slide members 154 and 156 are in turn coupled to linear potentiometers 158 and 160 via shafts 162 and 164. As shown, the slide members 154 and 156, shafts 162 and 164 and linear potentiometers 158 and 160 are arranged along generally perpendicular axes so that a first one of the potentiometers 158 measures movement of the joystick 122 along a first or x-axis 166, while the other of the potentiometers 160 measures movement of the joystick 122 along a second or y-axis 168. Preferably, the joystick 122 both moves within the slots 150 and 152 and causes one or both of the slide members 154 and 156 to move back and forth when the joystick 122 is actuated (i.e., pivoted) by the user. In this manner, the pivotal movement of the joystick 122 is translated into linear movement of the shaft 150 and 152 along the two axes 166 and 168. For example, if the user pivots the joystick 122 through an arc parallel to the x-axis 166, the joystick 122 causes the x-axis slide member 154 to move along the x-axis 166, sliding the x-axis shaft 162 with respect to the x-axis potentiometer 158, which detects the motion. The joystick 122 moves along the slot 152 in the y-axis slide member 156 so that the y-axis slide member 156 and shaft 164 do not move, so that no motion is detected by the y-axis potentiometer 160. Similarly, if the user pivots the joystick 122 through an arc parallel to the y-axis 168, the joystick 122 causes the y-axis slide member 156 to move along the y-axis 168, sliding the y-axis shaft 164 with respect to the y-axis potentiometer 160, while moving along the slot 154 in the x-axis slide member 154 so that the x-axis slide member 154 and shaft 162 do not move. Motion is thus detected by the y-axis potentiometer 160 and not the x-axis potentiometer 158. If, however, the user pivots the joystick 122 through an arc that is oblique to both the x and y-axes 166 and 168, the joystick 122 causes movement of both the x and y-axis slide members 154 and 156 to move along their respective axes 166 and 168, sliding both the x and y-axis shafts 162 and 164 with respect to both potentiometer 158 and 160. At the same time, the joystick 122 moves along the slots 150 and 152 in both of the x and y-axis slide members 154 and 156. Motion is thus detected by both the x-axis potentiometer 158 and the y-axis potentiometer 160. The analog output signals of the potentiometer 158 and 160 are converted to digital signals via an analog-to-digital converter (ADC), or the like, and provided to the processing system of the hand-held communication device, where the signals are mapped to correspond to the actual joystick movement and used as an input to a software application being executed by the processing system.

In other embodiments, shown in FIGS. 11, 12 and 13, the joystick 122 is coupled to a sliding base 170 positioned between spring assemblies 172 and 174 and slide members 176 and 178 or potentiometers 180 and 182 coupled to slide members 184 and 186. The spring assemblies 172 and 174 provide resistance to movement of the base 170 giving the user greater control of the movement of the joystick 122. When the joystick 122 is released, the spring assemblies 172 and 174 may cause the base 170 to return to a centered position, thereby recentering the joystick 122, or, alternatively, may allow the base 170, and thus the joystick 122, to remain in its last position before release by the user. The spring assemblies 172 and 174 may include a combination of compression and tension springs, electromechanical springs, shock absorber devices, or the like to provide resistance to movement of the joystick 122. Alternatively, the spring assemblies 172 and 174 may be eliminated and the rotary potentiometers 158 and 160 or 180 and 182 used for providing resistance to movement of the joystick 122.

As shown in FIG. 11, the slide members 176 and 178, which are generally T-shaped, are coupled to linear potentiometers 158 and 160. The slide members 176 and 178 and linear potentiometers 158 and 160 are arranged along generally perpendicular axes so that a first one of the potentiometers 158 measures movement of the joystick 122 along a first or x-axis 166, while the other of the potentiometers 160 measures movement of the joystick 122 along a second or y-axis 168. When the user actuates the joystick 122, the base 170 is moved in a direction corresponding to the direction of movement of the joystick 122 causing one or both of the slide members 176 and 178 to move back and forth along axes 166 and 168. The motion of the slide members 176 and 178 is detected by one or both of the x-axis potentiometer 158 and the y-axis potentiometer 160. The analog output signals of the potentiometers 158 and 160 are converted to digital signals via an analog-to-digital converter (ADC), or the like, and provided to the processing system of the hand-held communication device, where the signals are mapped to correspond to the actual joystick movement 122 and used as an input to a software application being executed by the processing system.

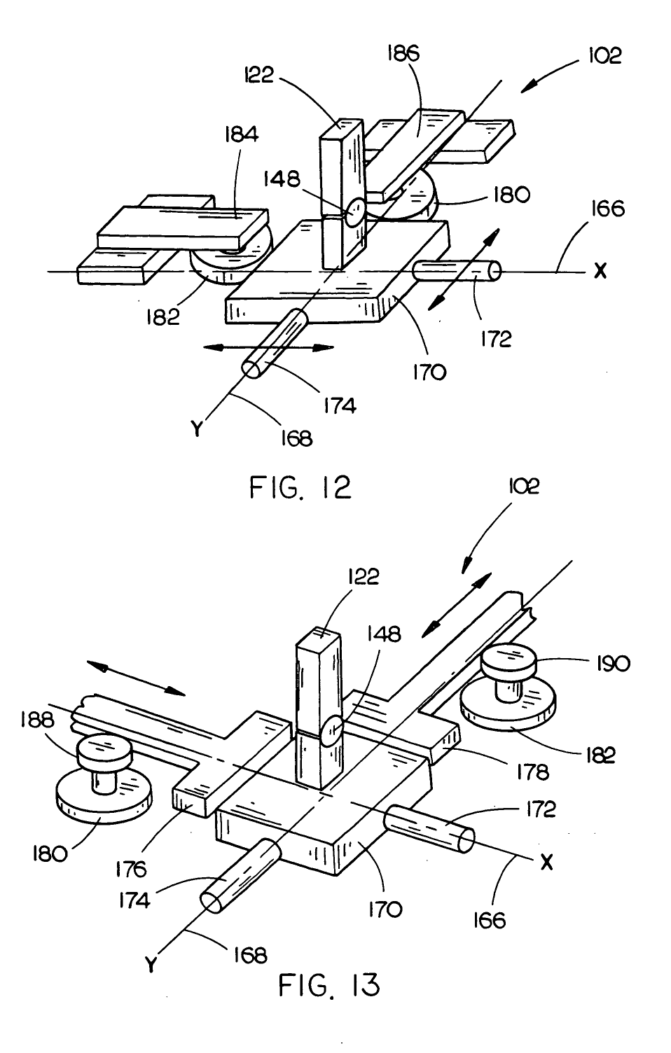

As shown in FIGS. 12 and 13, the slide members 176 and 178 or 184 and 186 may alternatively be coupled to rotary potentiometers 180 and 182. Like joystick assembly 102 shown in FIG. 11, the slide members 176 and 178 or 184 and 186 and potentiometers 180 and 182 of the joystick assemblies 102 shown in FIGS. 12 and 13 are arranged along generally perpendicular axes. In this manner, a first one of the potentiometers 180 measures movement of the base 170 along a first or x-axis 166, while the other of the potentiometers 182 measures movement of the joystick 122 along a second or y-axis 168. When the user actuates the joystick 122, the base 170 is moved in a direction corresponding to the direction of movement of the joystick 122 causing one or both of the slide members 176 and 178 or 184 and 186 to move back and forth along axes 166 and 168. In the embodiment shown in FIG. 12, the potentiometers 180 and 180 engage the base 170 for detecting motion of the base 170 caused by movement of the joystick 122. The x and y-axis potentiometers 180 and 182 move with the y and x-axis slide members 184 and 186, respectively, as the base 170 moves. In the embodiment shown in FIG. 13, the x and y-axis potentiometers 180 and 182 are coupled to rollers or gears 188 and 190 which rotate as the x- and y-axis slide members 176 and 178 are moved by the base 170. The motion of the slide members 176 and 178 is detected by one or both of the x-axis potentiometer 180 and the y-axis potentiometer 182. The analog output signals of the potentiometers 180 and 182 are converted to digital signals via an analog-to-digital converter (ADC), or the like, and provided to the processing system of the hand-held communication device, where the signals are mapped to correspond to the actual joystick movement and used as an input to a software application being executed by the processing system.

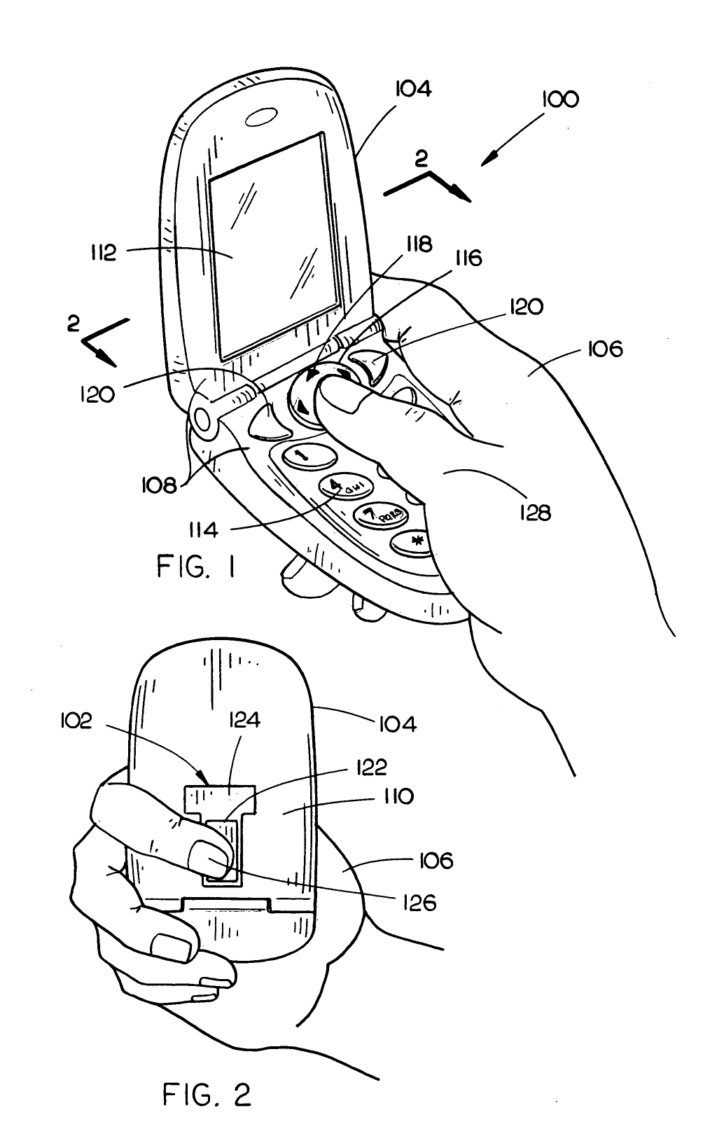

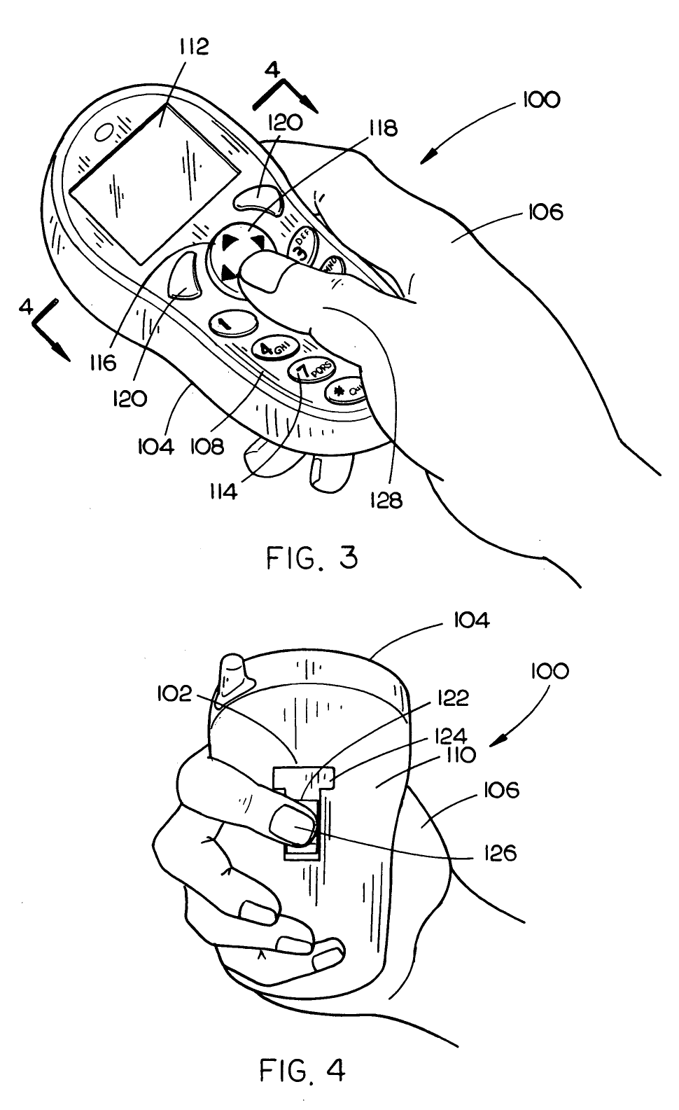

In FIGS. 1 through 13, the hand-held communication devices 100 illustrated are generally shown in “brick” form with most ornate features eliminated. However, those of ordinary skill in the art will recognize that mobile communication devices 100 in accordance with the present invention are not limited to the specific configurations disclosed herein, but instead may employ form factors having other ornamental or functional design features without departing from the scope and intent of the present invention. For example, FIGS. 1 and 2 illustrate the mobile communication device 100 embodied as a folding mobile telephone or “flip-phone” having a clam-shell housing, while FIGS. 3, 4, 5, 8 and 9 illustrate the hand-held communication device 100 embodied as a conventional mobile telephone having a unitary housing. However, it is contemplated that the folding joystick assembly 102 of the present invention may be implemented in other types of hand-held communication devices 100, including, but not limited to, mobile telephones having forms other than those specifically illustrated (e.g., mobile telephones having two-piece housings that slide with respect to one another), Personal Digital Assistants (PDA's), hand-held gaming devices, and the like. Further, those of skill in the art will appreciate that while potentiometers are utilized for measuring the position of the joystick 122 in the embodiments described, other movement measuring devices including digital measuring devices employing contact switches, or the like, may also be used without departing from the scope and intent of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A hand-held communication device, comprising:
a housing having a first surface and a second surface, the housing being configured to be held in a hand of a user so that the first surface generally faces toward the user while the user holds the housing and the second surface generally faces away from the user while the user holds the housing; and
a joystick assembly disposed in the second surface of the housing, the joystick assembly including a joystick for controlling a function of the hand-held communication device,
wherein the joystick folds between a first position within the housing for storage of the joystick and a second position extending from the housing for manipulation by the user.

2. The hand-held communication device as claimed in claim 1, wherein the joystick assembly further includes a potentiometer coupled to the joystick for detecting motion of the joystick.

3. The hand-held communication device as claimed in claim 2, wherein the potentiometer comprises a rotary potentiometer.

4. The hand-held communication device as claimed in claim 3, wherein the rotary potentiometer is inactive as the joystick is moved between the first position and the second position, and is active as the joystick is moved between the second position and a maximum travel position for detecting motion of the joystick between the second position and the maximum travel position.

5. The hand-held communication device as claimed in claim 2, wherein the potentiometer comprises a linear potentiometer.

6. The hand-held communication device as claimed in claim 1, wherein the joystick assembly comprises a first potentiometer, a second potentiometer, a first slide member for coupling the joystick to the first potentiometer and a second slide member for coupling the joystick to the second potentiometer.

7. The hand-held communication device as claimed in claim 6, wherein the second slide member overlaps the first slide member and is oriented perpendicularly to the first slide member, the joystick extending through slots disposed in the first and second slide members.

8. The hand-held communication device as claimed in claim 6, wherein the joystick assembly further comprises a sliding base for coupling the joystick to the first slide member and the second slide member.

9. The hand-held communication device as claimed in claim 1, wherein the joystick assembly further comprises a spring assembly for resisting movement of the joystick.

10. The hand-held communication device as claimed in claim 1, further comprising a navigation key assembly disposed on the first surface of the housing, the joystick assembly and the navigation key assembly cooperating for controlling a function of the hand-held communication device.

11. A joystick assembly for a hand-held communication device including a housing having a first surface and a second surface, the housing being configured to be held in a hand of a user so that the first surface generally faces toward the user while the user holds the housing and the second surface generally faces away from the user while the user holds the housing, comprising:
a joystick disposed in a recess formed in the second surface of the housing for controlling a function of the hand-held communication device; and
a potentiometer coupled to the joystick for detecting motion of the joystick,
wherein the joystick folds between a first position within the recess for storage of the joystick and a second position extending from the recess for allowing manipulation of the joystick by the user.

12. The joystick assembly as claimed in claim 11, wherein the potentiometer comprises a rotary potentiometer.

13. The joystick assembly as claimed in claim 12, wherein the rotary potentiometer is inactive as the joystick is moved between the first position and the second position, and is active as the joystick is moved between the second position and a maximum travel position for detecting motion of the joystick between the second position and the maximum travel position.

14. The joystick assembly as claimed in claim 11, wherein the potentiometer comprises a linear potentiometer.

15. The joystick assembly as claimed in claim 11, further comprising a second potentiometer, a first slide member for coupling the joystick to the potentiometer and a second slide member for coupling the joystick to the second potentiometer.

16. The joystick assembly as claimed in claim 15, wherein the second slide member overlaps the first slide member and is oriented perpendicularly to the first slide member, the joystick extending through slots disposed in the first and second slide members.

17. The joystick assembly as claimed in claim 15, further comprising a sliding base for coupling the joystick to the first slide member and the second slide member.

18. The joystick assembly as claimed in claim 15, further comprising a sliding base coupled to the joystick, the potentiometer and the second potentiometer engaging the sliding base for detecting movement of the sliding base.

19. The joystick assembly as claimed in claim 11, further comprising a spring assembly for resisting movement of the joystick.

20. A hand-held communication device, comprising:
a housing having a first surface and a second surface, the housing being configured to be held in a hand of a user so that the first surface generally faces toward the user while the user holds the housing and the second surface generally faces away from the user while the user holds the housing;
a navigation key assembly disposed in the first surface of the housing; and
a joystick assembly disposed in the second surface of the housing, the joystick assembly including a joystick folding between a first position within the housing for storage of the joystick and a second position extending from the housing for manipulation by the user,
wherein the joystick assembly and the navigation key assembly cooperate for controlling a function of the hand-held communication device.

21. The hand-held communication device as claimed in claim 20, wherein the joystick assembly further includes a potentiometer coupled to the joystick for detecting motion of the joystick.

22. The hand-held communication device as claimed in claim 21, wherein the potentiometer comprises a rotary potentiometer.

23. The hand-held communication device as claimed in claim 22, wherein the rotary potentiometer is inactive as the joystick is moved between the first position and the second position, and is active as the joystick is moved between the second position and a maximum travel position for detecting motion of the joystick between the second position and the maximum travel position.

24. The hand-held communication device as claimed in claim 21, wherein the potentiometer comprises a linear potentiometer.

25. The hand-held communication device as claimed in claim 20, wherein the joystick assembly comprises a first potentiometer, a second potentiometer, a first slide member for coupling the joystick to the first potentiometer and a second slide member for coupling the joystick to the second potentiometer.

26. The hand-held communication device as claimed in claim 25, wherein the second slide member overlaps the first slide member and is oriented perpendicularly to the first slide member, the joystick extending through slots disposed in the first and second slide members.

27. The hand-held communication device as claimed in claim 25, wherein the joystick assembly further comprises a sliding base for coupling the joystick assembly to the first slide member and the second slide member.

28. The hand-held communication device as claimed in claim 20, wherein the joystick assembly further comprises a spring assembly for resisting movement of the joystick.

29. A joystick assembly for a hand-held communication device including a housing having a first surface and a second surface, the housing being configured to be held in a hand of a user so that the first surface generally faces toward the user while the user holds the housing and the second surface generally faces away from the user while the user holds the housing, comprising:
a joystick disposed in a recess formed in the second surface of the housing for controlling a function of the hand-held communication device; and
means for detecting motion of the joystick,
wherein the joystick folds between a first position within the recess for storage of the joystick and a second position extending from the recess for allowing manipulation of the joystick by the user.

30. The joystick assembly as claimed in claim 29, further comprising means for resisting movement of the joystick.
